(19) United States
(12) Patent Application Publication
(10) Pub. No.: US 2026/0089749 A1
(43) Pub. Date: Mar. 26, 2026

(54) METHOD AND APPARATUS FOR CHANNEL ACCESS RELATED INFORMATION INDICATION IN CARRIER AGGREGATION SCENARIO

(71) Applicant: LENOVO (BEIJING) LIMITED, Beijing (CN)

(72) Inventor: Haipeng LEI, Beijing (CN)

(21) Appl. No.: 19/111,613

(22) PCT Filed: Dec. 23, 2022
(86) PCT No.: PCT/CN2022/141534

§ 371 Date: Mar. 13, 2025

(51) Int. Cl. H04W 74/00; H04L 27/26

(52) U.S. Cl. CPC H04W 74/004; H04L 27/2678

(57) ABSTRACT

Embodiments of the present disclosure relate to methods and apparatuses for channel access related information indication in a carrier aggregation (CA) scenario. According to some embodiments of the disclosure, a UE may: receive, from a base station (BS), a downlink control information (DCI) format scheduling a plurality of physical uplink shared channels (PUSCHs) on a plurality of cells of the UE; determine a channel access type, a channel access priority class (CAPC) value and a cyclic prefix extension (CPE) length for each of the plurality of PUSCHs; perform a channel access procedure for each of the plurality of PUSCHs according to the determined channel access type and CAPC value; and transmit, to the BS, a CPE with duration equal to the determined CPE length for a first PUSCH of the plurality of PUSCHs and the first PUSCH in response to a corresponding channel access procedure for the first PUSCH being successful.

### TECHNICAL FIELD

Embodiments of the present disclosure generally relate to wireless communication technology, and more particularly to a channel access related information indication in a carrier aggregation (CA) scenario.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a base station (BS) and a user equipment (UE) may communicate via downlink (DL) channels and uplink (UL) channels. For example, a UE may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). The BS and UE may communicate over licensed spectrums or unlicensed spectrums.

CA technology may be used in a wireless communication system to, for example, increase data rates. For example, CA technology may refer to aggregating spectrum resources (e.g., carriers or cells) from the same frequency band or different frequency bands. In a CA scenario, multiple cells may be configured for a UE and DL or UL channels may be carried on one or more of the multiple cells.

There is a need for facilitating communications on an unlicensed spectrum in a CA scenario.

### SUMMARY

Some embodiments of the present disclosure provide a user equipment (UE). The UE may include a transceiver, and a processor coupled to the transceiver. The processor may be configured to: receive, from a base station (BS), a downlink control information (DCI) format scheduling a plurality of physical uplink shared channels (PUSCHs) on a plurality of cells of the UE; determine a channel access type, a channel access priority class (CAPC) value and a cyclic prefix extension (CPE) length for each of the plurality of PUSCHs; perform a channel access procedure for each of the plurality of PUSCHs according to the determined channel access type, CAPC value and CPE length; and transmit, to the BS, a CPE with duration equal to the determined CPE length for a first PUSCH of the plurality of PUSCHs and the first PUSCH in response to a corresponding channel access procedure for the first PUSCH being successful.

In some embodiments of the present disclosure, a predefined CPE length is applied to all of the plurality of PUSCHs.

In some embodiments of the present disclosure, the DCI format indicates at least one of: a CPE length; a CAPC value; a first indicator for indicating a channel access type, CAPC value and CPE length for each of the plurality of PUSCHs; a second indicator for indicating the channel access type, CAPC value and CPE length for a predefined PUSCH of the plurality of PUSCHs; or a third indicator for indicating a single channel access type, a single CAPC value and a single CPE length for all of the plurality of PUSCHs.

In some embodiments of the present disclosure, in the case that the DCI format indicates a CAPC value; the indicated CAPC value is a first CAPC value used by the BS for initiating a channel occupancy time (COT): the indicated CAPC value is a second CAPC value to be used by the UE for performing a channel access procedure for transmitting a PUSCH; or the indicated CAPC value includes the first CAPC value and the second CAPC value.

In some embodiments of the present disclosure, in the case that more than one PUSCH of the plurality of PUSCHs is scheduled within a plurality of BS-initiated COTs, the first CAPC value is the minimum value of CAPC values used by the BS for initiating the plurality of BS-initiated COTs.

In some embodiments of the present disclosure, performing a channel access procedure for each of the plurality of PUSCHs according to the determined CAPC value includes performing a first type channel access procedure for a PUSCH of the plurality of PUSCHs according to the second CAPC value.

In some embodiments of the present disclosure, in the case that the DCI format indicates both a CAPC value and a CPE length, the CAPC value and the CPE length are indicated by separate fields in the DCI format, or jointly indicated by a single field in the DCI format.

In some embodiments of the present disclosure, in the case that the first, second or third indicator indicates a first type channel access procedure for a PUSCH of the plurality of PUSCHs, an associated CAPC value indicated by the first, second or third indicator is a CAPC value to be used by the UE for transmitting the PUSCH. In some embodiments of the present disclosure, in the case that the first, second or third indicator indicates a second type channel access procedure for a PUSCH of the plurality of PUSCHs, an associated CAPC value indicated by the first, second or third indicator is a CAPC value used by the BS for initiating a channel occupancy time (COT).

In some embodiments of the present disclosure, performing a channel access procedure for each of the plurality of PUSCHs according to the determined CAPC value includes performing a first type channel access procedure for the PUSCH according to the associated CAPC value in the case that the PUSCH is scheduled outside of a BS-initiated COT.

In some embodiments of the present disclosure, the first indicator indicates an entry of a table, and each entry of the table indicates a channel access type, a CAPC value and a CPE length for each of the plurality of PUSCHs.

In some embodiments of the present disclosure, the second indicator indicates an entry of a table, and each entry of the table indicates a single channel access type, a single CAPC value and a single CPE length for a predefined PUSCH among PUSCHs scheduled by a single DCI format.

In some embodiments of the present disclosure, the third indicator indicates an entry of a table, and each entry of the table indicates a single channel access type, a single CAPC value and a single CPE length for all PUSCHs scheduled by a single DCI format.

In some embodiments of the present disclosure, a size of the first, second, or the third indicator in the DCI format depends on the number of entries in the table.

In some embodiments of the present disclosure, in the case that a PUSCH of the plurality of PUSCHs is scheduled inside of a BS-initiated channel occupancy time (COT), the CAPC value used by the BS for initiating the BS-initiated COT is greater than or equal to a CAPC value of UL traffic data carried on the PUSCH.

Some embodiments of the present disclosure provide a BS. The BS may include a transceiver, and a processor coupled to the transceiver. The processor may be configured to: transmit, to a UE, a DCI format scheduling a plurality of PUSCHs on a plurality of cells of the UE; and receive, from the UE, a first PUSCH of the plurality of PUSCHs in response to a channel access procedure for the first PUSCH being successful, wherein the channel access procedure for the first PUSCH is performed by the UE according to a channel access type and a channel access priority class (CAPC) value, and wherein a cyclic prefix extension (CPE) is transmitted by the UE before the first PUSCH.

In some embodiments of the present disclosure, the DCI format indicates at least one of: a CPE length; a CAPC value; a first indicator for indicating a channel access type, CAPC value and CPE length for each of the plurality of PUSCHs; a second indicator for indicating the channel access type, CAPC value and CPE length for a predefined PUSCH of the plurality of PUSCHs; or a third indicator for indicating a single channel access type, a single CAPC value and a single CPE length for all of the plurality of PUSCHs.

In some embodiments of the present disclosure, in the case that the DCI format indicates a CPE length; the indicated CPE length is applied to all of the plurality of PUSCHs; the indicated CPE length is applied to all PUSCHs that require a first type channel access procedure among the plurality of PUSCHs and a predefined CPE length is applied to the remaining PUSCHs of the plurality of PUSCHs; the indicated CPE length is applied to all PUSCHs that require a second type channel access procedure among the plurality of PUSCHs and a predefined CPE length is applied to the remaining PUSCHs of the plurality of PUSCHs; the indicated CPE length is applied to a predefined PUSCH among the plurality of PUSCHs and a predefined CPE length is applied to the remaining PUSCHs of the plurality of PUSCHs; or the indicated CPE length includes a first CPE length to be applied to all PUSCHs that require a first type channel access procedure among the plurality of PUSCHs, and a second CPE length to be applied to all PUSCHs that require a second type channel access procedure among the plurality of PUSCHs.

In some embodiments of the present disclosure, a predefined CPE length is applied to all of the plurality of PUSCHs.

In some embodiments of the present disclosure, in the case that the DCI format indicates a CAPC value; the indicated CAPC value is a first CAPC value used by the BS for initiating a COT; the indicated CAPC value is a second CAPC value to be used by the UE for performing channel access procedure for transmitting a PUSCH; or the indicated CAPC value includes the first CAPC value and the second CAPC value.

In some embodiments of the present disclosure, the processor is further configured to: in the case the first CAPC value is greater than or equal to a CAPC value of UL traffic data carried on a PUSCH of the plurality of PUSCHs that requires a second type channel access procedure, attempt to receive the PUSCH. In some embodiments of the present disclosure, the processor is further configured to: in the case the first CAPC value is smaller than the CAPC value of the UL traffic data carried on the PUSCH, determine that the transmission of the PUSCH is terminated.

In some embodiments of the present disclosure, in the case that more than one PUSCH of the plurality of PUSCHs is scheduled within a plurality of BS-initiated COTs, the first CAPC value is the minimum value of CAPC values used by the BS for initiating the plurality of BS-initiated COTs.

In some embodiments of the present disclosure, in the case that a PUSCH of the plurality of PUSCHs requires a first type channel access procedure, a first type channel access procedure is performed by the UE for transmitting the PUSCH according to the second CAPC value.

In some embodiments of the present disclosure, in the case that the DCI format indicates both a CAPC value and a CPE length, the CAPC value and the CPE length are indicated by separate fields in the DCI format, or jointly indicated by a single field in the DCI format.

In some embodiments of the present disclosure, in the case that a PUSCH of the plurality of PUSCHs requires a first type channel access procedure, a CAPC value for the PUSCH is determined according to UL traffic data carried on the PUSCH.

In some embodiments of the present disclosure, a first type channel access procedure is required for all of the plurality of PUSCHs. In some embodiments of the present disclosure, in the case that a PUSCH of the plurality of PUSCHs is scheduled outside of a BS-initiated COT, a first type channel access procedure is required for the UE for transmitting the PUSCH. In some embodiments of the present disclosure, in the case that the PUSCH is scheduled inside of a BS-initiated COT, a second type channel access procedure is required for the UE for transmitting the PUSCH.

In some embodiments of the present disclosure, in the case that the first, second or third indicator indicates a first type channel access procedure for a PUSCH of the plurality of PUSCHs, an associated CAPC value indicated by the first, second or third indicator is a CAPC value to be used by the UE for transmitting the PUSCH. In some embodiments of the present disclosure, in the case that the first, second or third indicator indicates a second type channel access procedure for a PUSCH of the plurality of PUSCHs, an associated CAPC value indicated by the first, second or third indicator is a CAPC value used by the BS for initiating a COT.

In some embodiments of the present disclosure, in the case that the PUSCH is scheduled outside of a BS-initiated COT, the channel access procedure for the PUSCH is a first type channel access procedure performed according to the associated CAPC value.

In some embodiments of the present disclosure, the processor is further configured to: in the case that the PUSCH is scheduled inside of a BS-initiated COT, attempt to receive the PUSCH when the associated CAPC value is greater than or equal to a CAPC value of UL traffic data carried on the PUSCH. In some embodiments of the present disclosure, the processor is further configured to: in the case that the PUSCH is scheduled inside of a BS-initiated COT, determine that the transmission of the PUSCH is terminated when the associated CAPC value is smaller than the CAPC value of the UL traffic data carried on the PUSCH.

In some embodiments of the present disclosure, a predefined CPE length is applied to all of the plurality of PUSCHs except the predefined PUSCH.

In some embodiments of the present disclosure, a first type channel access procedure is required for all of the plurality of PUSCHs except the predefined PUSCH.

In some embodiments of the present disclosure, for a corresponding PUSCH of the plurality of PUSCHs except the predefined PUSCH, in the case that the corresponding PUSCH is scheduled outside of a BS-initiated COT, a first type channel access procedure is required for the corresponding PUSCH and a CAPC value for the corresponding PUSCH is determined according to UL traffic data carried on the corresponding PUSCH. In some embodiments of the present disclosure, for a corresponding PUSCH of the plurality of PUSCHs except the predefined PUSCH, in the case that the corresponding PUSCH is scheduled inside of a BS-initiated COT, a second type channel access procedure is required for the corresponding PUSCH.

In some embodiments of the present disclosure, the predefined PUSCH is: the first scheduled PUSCH among the plurality of PUSCHs; the last scheduled PUSCH among the plurality of PUSCHs; a PUSCH among the plurality of PUSCHs scheduled on a cell with the lowest cell index among the plurality of cells; a PUSCH among the plurality of PUSCHs scheduled on a cell with the largest cell index among the plurality of cells; the first scheduled PUSCH among PUSCHs which require a first type channel access procedure among the plurality of PUSCHs; the last scheduled PUSCH among PUSCHs which require a first type channel access procedure among the plurality of PUSCHs; a PUSCH on a cell with the lowest cell index among PUSCHs which require a first type channel access procedure among the plurality of PUSCHs; a PUSCH on a cell with the largest cell index among PUSCHs which require a first type channel access procedure among the plurality of PUSCHs; the first scheduled PUSCH among PUSCHs which require a second type channel access procedure among the plurality of PUSCHs; the last scheduled PUSCH among PUSCHs which require a second type channel access procedure among the plurality of PUSCHs; a PUSCH on a cell with the lowest cell index among PUSCHs which require a second type channel access procedure among the plurality of PUSCHs; or a PUSCH on a cell with the largest cell index among PUSCHs which require a second type channel access procedure among the plurality of PUSCHs.

In some embodiments of the present disclosure, the first indicator indicates an entry of a table, and each entry of the table indicates a channel access type, a CAPC value and a CPE length for each of the plurality of PUSCHs.

In some embodiments of the present disclosure, the second indicator indicates an entry of a table, and each entry of the table indicates a single channel access type, a single CAPC value and a single CPE length for a predefined PUSCH among PUSCHs scheduled by a single DCI format.

In some embodiments of the present disclosure, the third indicator indicates an entry of a table, and each entry of the table indicates a single channel access type, a single CAPC value and a single CPE length for all PUSCHs scheduled by a single DCI format.

In some embodiments of the present disclosure, a size of the first, second, or the third indicator in the DCI format depends on the number of entries in the table.

In some embodiments of the present disclosure, in the case that a PUSCH of the plurality of PUSCHs is scheduled inside of a BS-initiated COT, the CAPC value used by the BS for initiating the BS-initiated COT is greater than or equal to a CAPC value of UL traffic data carried on the PUSCH.

Some embodiments of the present disclosure provide a method performed by a UE. The method may include: receiving, from a BS, a DCI format scheduling a plurality of PUSCHs on a plurality of cells of the UE; determining a channel access type, a CAPC value and a CPE length for each of the plurality of PUSCHs: performing a channel access procedure for each of the plurality of PUSCHs according to the determined channel access type, CAPC value and CPE length; and transmitting, to the BS, a CPE with duration equal to the determined CPE length for a first PUSCH of the plurality of PUSCHs and the first PUSCH in response to a corresponding channel access procedure for the first PUSCH being successful.

Some embodiments of the present disclosure provide a method performed by a BS. The method may include: transmitting, to a UE, a DCI format scheduling a plurality of PUSCHs on a plurality of cells of the UE; and receiving, from the UE, a first PUSCH of the plurality of PUSCHs in response to a channel access procedure for the first PUSCH being successful, wherein the channel access procedure for the first PUSCH is performed by the UE according to a channel access type and a channel access priority class (CAPC) value, and wherein a cyclic prefix extension (CPE) is transmitted by the UE before the first PUSCH.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure:

FIGS. 2 and 3 illustrate schematic diagrams of a DCI format scheduling a plurality of transmissions in accordance with some embodiments of the present disclosure:

FIG. 4 illustrates a schematic diagram of a DCI format scheduling a plurality of PUSCHs over an unlicensed spectrum in accordance with some embodiments of the present disclosure;

FIGS. 5 and 6 illustrate flow charts of an exemplary procedure of wireless communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

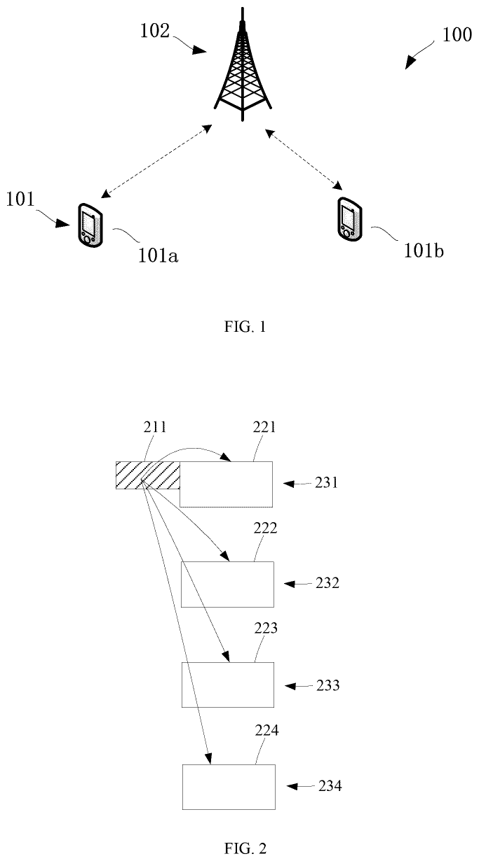

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A communication technology (e.g., NR) may support a wide range of spectrums in different frequency ranges. For example, in the market for 5G Advanced, it is expected that the availability of the spectrum will be increased, which is possibly due to re-farming the bands originally used for previous cellular generation networks. For example, for some low frequency bands of frequency range 1 (FR1) (e.g., 410 MHz-7125 MHz), the available spectrum bands tend to be more fragmented and scattered with a narrower bandwidth. In addition, for bands of frequency range 2 (FR2) (e.g., 24250 MHz-52600 MHz) and some bands of FR1, the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth become available, it is advisable to allow simultaneous scheduling of multiple cells.

A communication system (e.g., NR) may be designed to support a maximum of 16 component carriers (CCs) in the case of carrier aggregation (CA) or a maximum of 32 CCs in the case of dual connectivity (DC). In some embodiments of the present application, in the case of CA, one DCI format can schedule at most one carrier by cross-carrier scheduling or self-scheduling. This requires much signaling overhead for PDCCHs to schedule PDSCHs or PUSCHs when the number of carriers configured for a UE is large. To reduce signaling overhead, it would be beneficial to use a single DCI format to schedule multiple PDSCHs or PUSCHs on multiple carriers configured for the UE, which is referred to as multi-cell or multi-carrier scheduling in the context of the present disclosure. Meanwhile, a tradeoff between signaling overhead reduction and scheduling restriction has to be taken into account.

In the context of the present disclosure, for simplicity, a DCI format scheduling multiple PUSCHs on multiple cells is referred to as DCI format 0_X, and a DCI format scheduling multiple PDSCHs on multiple cells is referred to as DCI format 1 X. In some embodiments of the present disclosure, a DCI format 0_X/1_X may schedule a single PDSCH per cell.

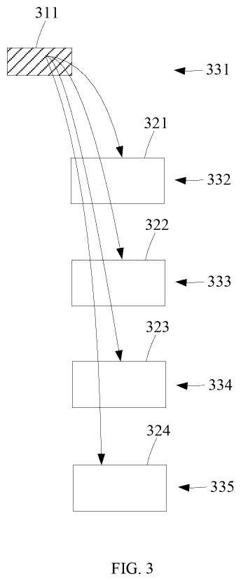

FIG. 2 illustrates a schematic diagram of a DCI format scheduling a plurality of transmissions in accordance with some embodiments of the present disclosure.

In some embodiments of the present disclosure, a plurality of CCs (e.g., including but not limited to CCs 231-234 in FIG. 2) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each cell (serving cell) may be associated with a (serving) cell index.

In some embodiments of the present disclosure, instead of using separate DCI formats to respectively schedule a plurality of transmissions on a plurality of carriers, a BS may transmit a single DCI format to schedule the plurality of transmissions on the plurality of carriers. For example, as shown in FIG. 2, DCI format 211 may schedule transmissions 221-224 on CCs 231-234, where each CC carries a single transmission.

In some examples, transmissions 221-224 may be uplink transmissions, for example, uplink physical data channels such as PUSCHs. In some examples, transmissions 221-224 may be downlink transmissions, for example, downlink physical data channels such as PDSCHs.

In FIG. 2, the carrier (i.e., CC 231) on which DCI format 211 is detected carries one (e.g., transmission 221) of the scheduled transmissions. This may be referred to as self-scheduling. Other transmissions (e.g., transmissions 222-224) of the scheduled transmissions are scheduled on carriers different from the one (i.e., CC 231) on which DCI format 211 is detected. This may be referred to as cross-carrier scheduling.

Although in FIG. 2, DCI format 211 schedules a plurality of transmissions via both self-scheduling and cross-carrier scheduling, it should be understood that a DCI format may schedule a plurality of transmissions via only cross-carrier scheduling. FIG. 3 shows such an example. It also should be understood that a carrier (e.g., a CC) scheduled by a DCI format may carry more than one transmission (e.g., PDSCHs or PUSCHs) in some other embodiments of the present disclosure.

FIG. 3 illustrates a schematic diagram of a DCI format scheduling a plurality of transmissions in accordance with some embodiments of the present disclosure.

In some embodiments of the present disclosure, a plurality of CCs (e.g., including but not limited to CCs 331-335 in FIG. 3) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each cell (serving cell) may be associated with a (serving) cell index.

As shown in FIG. 3, DCI format 311 may be transmitted on CC 331, and schedule transmissions 321-324 on CCs 332-335, where each CC carries a single transmission. In some examples, transmissions 321-324 may be uplink transmissions, for example, uplink physical data channels such as PUSCHs. In some examples, transmissions 321-324 may be downlink transmissions, for example, downlink physical data channels such as PDSCHs.

The payload size of a single DCI may be limited, for example, a maximum of a 140-bit payload size may be required. When a single DCI is used to schedule multiple cells, the payload size of the DCI can easily exceed the payload size limitation (e.g., 140 bits) due to that many fields in the DCI are cell-specific, including for example but not limited to, modulation and coding scheme (MCS), hybrid automatic repeat request (HARQ) process number, new data indicator (NDI), redundancy version (RV), and/or frequency domain resource assignment (FDRA). Hence, payload size reduction may be required to ensure that the total payload size of a DCI does not exceed the payload size limitation (e.g., 140 bits).

In some embodiments of the present disclosure, for unlicensed spectrum operations, a DCI format may need to indicate channel access related information. For example, a DCI format (e.g., DCI format 0_1) may include a field (hereinafter, referred to as “channel access information related field”) indicating a channel access type, a CAPC value, and a CPE length for a transmission (e.g., a PUSCH) scheduled by the DCI format. For example, before transmitting the scheduled PUSCH, a UE may need to perform a channel access procedure (also known as listen-before-talk (LBT) test or procedure) according to the indicated channel access type and CAPC, and in response to a successful channel access procedure, the UE may transmit a CPE with duration equal to the indicated CPE length and the scheduled PUSCH.

The channel access type may indicate a first type channel access procedure (e.g., Type 1 UL channel access procedure as specified in 3GPP specifications) and a second type channel access procedure (e.g., Type 2 UL channel access procedure as specified in 3GPP specifications). In some examples, depending on the sensing time, the second type channel access procedure may include more than one channel access procedure, for example, Type 2A UL channel access procedure, Type 2B UL channel access procedure, and Type 2C UL channel access procedure as specified in 3GPP specifications.

In some embodiments of the present disclosure, the channel access information related field may indicate an entry in a table, which may be configured or predefined for a UE. The table may include a plurality of entries, each indicating a channel access type, CAPC, and CPE length. As an example, the table may be defined as follows.

TABLE A

| Entry index | Channel Access Type | CP extension | CAPC |
|---|---|---|---|
| 0 | Type2C-ULChannelAccess | 0 | 1 |
| 1 | Type2C-ULChannelAccess | 0 | 2 |
| 2 | Type2C-ULChannelAccess | 0 | 3 |
| 3 | Type2C-ULChannelAccess | 0 | 4 |
| 4 | Type2C-ULChannelAccess | 2 | 1 |
| 5 | Type2C-ULChannelAccess | 2 | 2 |
| 6 | Type2C-ULChannelAccess | 2 | 3 |
| 7 | Type2C-ULChannelAccess | 2 | 4 |
| 8 | Type2B-ULChannelAccess | 0 | 1 |
| 9 | Type2B-ULChannelAccess | 0 | 2 |
| 10 | Type2B-ULChannelAccess | 0 | 3 |
| 11 | Type2B-ULChannelAccess | 0 | 4 |
| 12 | Type2B-ULChannelAccess | 2 | 1 |
| 13 | Type2B-ULChannelAccess | 2 | 2 |
| 14 | Type2B-ULChannelAccess | 2 | 3 |
| 15 | Type2B-ULChannelAccess | 2 | 4 |
| 16 | Type2A-ULChannelAccess | 0 | 1 |
| 17 | Type2A-ULChannelAccess | 0 | 2 |
| 18 | Type2A-ULChannelAccess | 0 | 3 |
| 19 | Type2A-ULChannelAccess | 0 | 4 |
| 20 | Type2A-ULChannelAccess | 1 | 1 |
| 21 | Type2A-ULChannelAccess | 1 | 2 |
| 22 | Type2A-ULChannelAccess | 1 | 3 |
| 23 | Type2A-ULChannelAccess | 1 | 4 |
| 24 | Type2A-ULChannelAccess | 3 | 1 |
| 25 | Type2A-ULChannelAccess | 3 | 2 |
| 26 | Type2A-ULChannelAccess | 3 | 3 |
| 27 | Type2A-ULChannelAccess | 3 | 4 |
| 28 | Type1-ULChannelAccess | 0 | 1 |
| 29 | Typel-ULChannelAccess | 0 | 2 |
| 30 | Type1-ULChannelAccess | 0 | 3 |
| 31 | Type1-ULChannelAccess | 0 | 4 |
| 32 | Type1-ULChannelAccess | 1 | 1 |
| 33 | Type1-ULChannelAccess | 1 | 2 |
| 34 | Typel-ULChannelAccess | 1 | 3 |
| 35 | Typel-ULChannelAccess | 1 | 4 |
| 36 | Type1-ULChannelAccess | 2 | 1 |
| 37 | Typel-ULChannelAccess | 2 | 2 |
| 38 | Type1-ULChannelAccess | 2 | 3 |
| 39 | Type1-ULChannelAccess | 2 | 4 |
| 40 | Typel-ULChannelAccess | 3 | 1 |
| 41 | Type1-ULChannelAccess | 3 | 2 |
| 42 | Typel-ULChannelAccess | 3 | 3 |
| 43 | Typel-ULChannelAccess | 3 | 4 |

Since there are 44 entries defined in the above exemplary table, then a maximum of 6 bits is included in the DCI format for indicating channel access related information for the scheduled PUSCH.

In the case of multi-cell scheduling, considering that the scheduled PUSCHs on different cells may have different settings, it may be desirable to indicate a dedicated channel access information related field for each scheduled PUSCH to ensure scheduling flexibility. However, in the example of Table A, assuming that a maximum of 4 PUSCHs is schedulable by a single DCI, then a maximum of 24 (i.e., 6×4) bits would be required in the multi-cell scheduling DCI. This solution thus causes too much payload to be included in the DCI and would cause the total payload size of a DCI to easily exceed the payload size limitation (e.g., 140 bits).

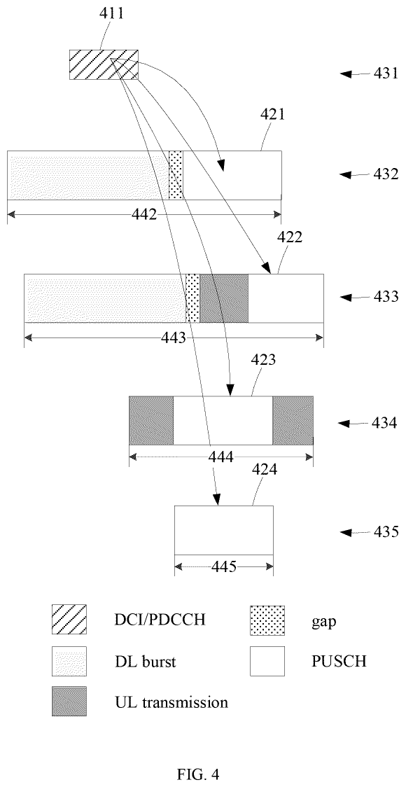

FIG. 4 illustrates a schematic diagram of a DCI format scheduling a plurality of PUSCHs over an unlicensed spectrum in accordance with some embodiments of the present disclosure.

In some embodiments of the present disclosure, a plurality of CCs (e.g., including but not limited to CCs 431-435 in FIG. 4) may be configured for a UE. It should be understood that the sub-carrier spacings (SCSs) of the carriers configured for a UE may be the same or different. Each of the plurality of CCs may correspond to a respective cell (e.g., serving cell) or carrier of the UE. Each cell (serving cell) may be associated with a (serving) cell index. As shown in FIG. 4, DCI format 411 may be transmitted on CC 431, and schedule PUSCHs 421-424 on CCs 432-435, where each CC carries a single PUSCH.

PUSCH 421 may be located inside of BS-initiated COT 442 and separated by a gap between DL burst and UL burst, and therefore a second type channel access procedure (e.g., Type 2A channel access procedure) may be needed for the UE to transmit PUSCH 421. PUSCH 422 may be located inside of BS-initiated COT 443 and follow another UL transmission within the UL burst, and therefore a second type channel access procedure (e.g., Type 2B or Type 2C channel access procedure) may be needed for the UE to transmit PUSCH 422. PUSCH 423 may be located inside of UE-initiated COT 444 and follow another UL transmission. Therefore, a first type channel access procedure (e.g., Type 1 channel access procedure) may be needed for the UE to transmit PUSCH 423 if the channel access procedure for the UL transmission before PUSCH 423 fails: or a second type channel access procedure (e.g., Type 2A, 2B or 2C channel access procedure) or no channel access procedure (i.e., no LBT) may be needed for the UE to transmit PUSCH 423 if the channel access procedure for the UL transmission before PUSCH 423 is successful and PUSCH 423 is inside of UE-initiated COT 444. PUSCH 424 may be located inside of UE-initiated COT 445 and follow no UL transmission, and therefore a first type channel access procedure (e.g., Type 1 channel access procedure) may be needed for the UE to transmit PUSCH 424.

In the example of FIG. 4, if separate channel access information related fields are included in DCI format 411 with each corresponding to one PUSCH, it may cause too much payload to be included in the DCI format and would cause the total payload size of the DCI format to exceed the payload size limitation since each field may require up to, for example, 6 bits in the DCI format. Therefore, a tradeoff between payload size overhead reduction and scheduling restriction has to be taken into account.

Embodiments of the present disclosure provide solutions for indicating channel access related information in the case of multi-cell scheduling. The disclosed solutions avoid excess payload size overhead in a multi-cell scheduling DCI format. More details on the embodiments of the present disclosure will be illustrated in the following text in combination with the appended drawings.

In some embodiments of the present disclosure, when a DCI format schedules a plurality of PUSCHs on a plurality of cells, the DCI format may only indicate a CPE length for the PUSCHs co-scheduled by the DCI format. Neither the channel access type nor CAPC value may be indicated in the DCI format.

In the context of the present disclosure, a CPE length for a PUSCH, applying a CPE length to a PUSCH or other similar expressions may suggest that before the PUSCH is transmitting by a UE, the UE may transmit a CPE with a duration equal to the CPE length. However, from the perspective of a BS, it may only receive the PUSCH.

In some embodiments, the CAPC value for performing a first channel access procedure for a PUSCH scheduled by the DCI format may be associated with the UL traffic data carried on the PUSCH. For example, for a PUSCH scheduled by the DCI format and requiring a first channel access procedure, the UE may determine the corresponding CAPC value according to the UL traffic data to be transmitted on the PUSCH. In the case that a PUSCH is scheduled inside of a BS-initiated COT or requires or can use a second channel access procedure, a BS should ensure that the CAPC value used by the BS for initiating the COT is greater than or equal to the CAPC value associated with the UL traffic data carried on the PUSCH.

In some embodiments of the present disclosure, a first type channel access procedure may be required for all of the plurality of PUSCHs. That is, the first type channel access procedure is mandated for transmitting the plurality of PUSCHs on the plurality of cells.

In some other embodiments of the present disclosure, for each of the plurality of co-scheduled PUSCHs, the channel access type for a corresponding PUSCH may be determined based on whether the corresponding PUSCH is scheduled inside or outside of a BS-initiated COT.

For example, for a specific PUSCH of the plurality of co-scheduled PUSCHs, the UE can determine whether the PUSCH is scheduled inside or outside of a BS-initiated COT. In response to determining that the PUSCH is scheduled outside of a BS-initiated COT, it is determined that a first type channel access procedure is required for the PUSCH. Otherwise, in response to determining that the PUSCH is scheduled inside of a BS-initiated COT, it is determined that a second type channel access procedure is required or can be used for the PUSCH.

For example, a UE may receive a DCI format (e.g., DCI format 2_0) indicating a COT duration (e.g., a remaining COT duration indicator). Based on the remaining COT duration indicator and the time domain resource allocation information indicated in the DCI format scheduling the plurality of PUSCHs, the UE can determine whether a scheduled PUSCH is located inside or outside of a BS-initiated COT. In response to determining that the scheduled PUSCH is located outside of a BS-initiated COT, the UE may perform a first type channel access procedure before transmitting the scheduled PUSCH. Otherwise, in response to determining that the scheduled PUSCH is located inside of a BS-initiated COT, the UE may perform a second type channel access procedure before transmitting the scheduled PUSCH.

Furthermore, in the case that the scheduled PUSCH is located inside of a BS-initiated COT, the UE can further determine the duration of the gap between the scheduled PUSCH and the DL or UL transmission (if any) immediately before the scheduled PUSCH. In the case that the duration of the gap is greater than 25 μs, the UE may perform a Type 2A channel access procedure before transmitting the scheduled PUSCH. In the case that the duration of the gap is equal to 16 μs, the UE may perform a Type 2B channel access procedure before transmitting the scheduled PUSCH. In the case that the duration of the gap is less than 16 μs, the UE may perform a Type 2C channel access procedure before transmitting the scheduled PUSCH.

The CPE length indication in the DCI format can be implemented in various manners.

For example, in some embodiments of the present disclosure, the CPE length indicated in the DCI format scheduling the plurality of PUSCHs may be applied to all of the plurality of PUSCHs. For instance, a single CPE length may be indicated in a multi-cell scheduling DCI format and may be applicable to all the co-scheduled PUSCHs. In other words, all the PUSCHs co-scheduled by the same DCI format have the same CPE length.

In some embodiments of the present disclosure, the indicated CPE length may be applied to all PUSCHs that require a first type channel access procedure among the plurality of PUSCHs co-scheduled by the DCI format. For instance, a single CPE length may be indicated in a multi-cell scheduling DCI format and may be applicable to all the co-scheduled PUSCHs with a first type channel access procedure to be performed. That is, for the co-scheduled PUSCHs which require a first type channel access procedure, the indicated CPE length is used (if the corresponding first type channel access procedure is successful). A predefined CPE length (e.g., “0”) may be applied to the remaining PUSCHs of the plurality of PUSCHs. For instance, for the co-scheduled PUSCHs which require or can use a second type channel access procedure, a predefined CPE is used (if the corresponding second type channel access procedure is successful).

In some embodiments of the present disclosure, the indicated CPE length may be applied to all PUSCHs that require or can use a second type channel access procedure among the plurality of PUSCHs co-scheduled by the DCI format. For instance, a single CPE length may be indicated in a multi-cell scheduling DCI format and may be applicable to all the co-scheduled PUSCHs with a second type channel access procedure to be performed. That is, for the co-scheduled PUSCHs which require or can use a second type channel access procedure, the indicated CPE length is used (if the corresponding second type channel access procedure is successful). A predefined CPE length (e.g., “0”) may be applied to the remaining PUSCHs of the plurality of PUSCHs. For instance, for the co-scheduled PUSCHs which require a first type channel access procedure, a predefined CPE is used (if the corresponding first type channel access procedure is successful).

In some embodiments of the present disclosure, the indicated CPE length may be applied to a predefined PUSCH among the plurality of PUSCHs co-scheduled by the DCI format. A predefined CPE length (e.g., “0”) may be applied to the remaining PUSCHs of the plurality of PUSCHs.

For example, the predefined PUSCH may be: the first scheduled PUSCH among the plurality of PUSCHs co-scheduled by the DCI format: the last scheduled PUSCH among the plurality of PUSCHs; the PUSCH among the plurality of PUSCHs scheduled on a cell with the lowest cell index among the plurality of cells co-scheduled by the DCI format: the PUSCH among the plurality of PUSCHs scheduled on a cell with the largest cell index among the plurality of cells; the first scheduled PUSCH among PUSCHs which require a first type channel access procedure among the plurality of PUSCHs; the last scheduled PUSCH among PUSCHs which require a first type channel access procedure among the plurality of PUSCHs; the PUSCH on a cell with the lowest cell index among PUSCHs which require a first type channel access procedure among the plurality of PUSCHs; the PUSCH on a cell with the largest cell index among PUSCHs which require a first type channel access procedure among the plurality of PUSCHs; the first scheduled PUSCH among PUSCHs which require a second type channel access procedure among the plurality of PUSCHs; the last scheduled PUSCH among PUSCHs which require a second type channel access procedure among the plurality of PUSCHs; the PUSCH on a cell with the lowest cell index among PUSCHs which require a second type channel access procedure among the plurality of PUSCHs; or the PUSCH on a cell with the largest cell index among PUSCHs which require a second type channel access procedure among the plurality of PUSCHs.

In some embodiments of the present disclosure, the indicated CPE length may include two CPE lengths, wherein one may be applied to all PUSCHs that require a first type channel access procedure among the plurality of PUSCHs co-scheduled by the DCI format, and the other one may be applied to all PUSCHs that require a second type channel access procedure among the plurality of PUSCHs. For instance, the DCI format may include two separate CPE length fields. One of the CPE length fields is applicable to all the co-scheduled PUSCHs with the first type channel access procedure performed, i.e., for those co-scheduled PUSCHs which require the first type channel access procedure; and the other field is applicable to all the co-scheduled PUSCHs with the second type channel access procedure performed, i.e., for those co-scheduled PUSCHs which require or can use the second type channel access procedure.

In some embodiments of the present disclosure, besides the channel access type and CAPC value, the CPE length may also not be indicated in the DCI format scheduling the plurality of PUSCHs. A predefined CPE length may be applied to all of the plurality of co-scheduled PUSCHs. For example, the CPE length of “0” may be used for transmitting each of the co-scheduled PUSCHs.

In some embodiments of the present disclosure, when a DCI format schedules a plurality of PUSCHs on a plurality of cells, the DCI format may indicate a CAPC value, or both a CPE length and the CAPC value for the PUSCHs co-scheduled by the DCI format. The channel access type may not be indicated in the DCI format.

In the case that both the CPE length and CAPC value are indicated in the DCI format, the CPE length and CAPC value may be indicated separately or jointly. For example, the CAPC value and the CPE length may be indicated by separate fields in the DCI format, or jointly indicated by a single field in the DCI format. In the case of joint indication, the single field in the DCI format may point to an entry of a table, where each entry of the table indicates both a CAPC value and a CPE length. The table may be configured by a BS (e.g., via radio resource control (RRC) signaling) or predefined. In the case that the CPE length is not indicated in the DCI format, a predefined CPE length (e.g., “0”) may be applied to all of the plurality of PUSCHs scheduled by the DCI format.

In some embodiments of the present disclosure, a first type channel access procedure may be required for all of the plurality of PUSCHs. That is, the first type channel access procedure is mandated for transmitting the plurality of PUSCHs on the plurality of cells scheduled by the DCI format.

In some other embodiments of the present disclosure, for each of the plurality of co-scheduled PUSCHs, the channel access type for a corresponding PUSCH may be determined based on whether the corresponding PUSCH is scheduled inside or outside of a BS-initiated COT.

For example, for a certain PUSCH of the plurality of co-scheduled PUSCHs, the UE can determine whether the PUSCH is scheduled inside or outside of a BS-initiated COT. In response to determining that the PUSCH is scheduled outside of a BS-initiated COT, it is determined that a first type channel access procedure is required for the PUSCH. Otherwise, in response to determining that the PUSCH is scheduled inside of a BS-initiated COT, it is determined that a second type channel access procedure is required or can be used for the PUSCH.

For example, as described above, based on the remaining COT duration indicator in DCI format 2_0 and the time domain resource allocation information indicated in the DCI format scheduling the plurality of PUSCHs, a UE can determine whether a scheduled PUSCH is located inside or outside of a BS-initiated COT. In the case that the scheduled PUSCH is located inside of a BS-initiated COT, the UE can further determine the duration of the gap between the scheduled PUSCH and the DL or UL transmission (if any) immediately before the scheduled PUSCH. The UE can determine whether to perform a first type channel access procedure (e.g., Type 1 channel access procedure) or a second type channel access procedure (e.g., Type 2 channel access procedure such as Type 2A, 2B or 2C channel access procedure) before transmitting the scheduled PUSCH.

The CAPC value indication in the DCI format can be implemented in various manners.

For example, in some embodiments of the present disclosure, the CAPC value (denoted as CAPC #1 for simplicity) indicated in the DCI format scheduling the plurality of PUSCHs may be the CAPC value used by the BS for initiating a COT.

For instance, a single CAPC value may be indicated in a multi-cell scheduling DCI format and may be the CAPC value used by the BS for initiating a COT. In some embodiments, in the case that more than one PUSCH of the plurality of PUSCHs scheduled by the DCI format is scheduled within a plurality of BS-initiated COTs, CAPC #1 may be the minimum value of CAPC values used by the BS for initiating the plurality of BS-initiated COTs.

In some embodiments, for a PUSCH scheduled by the DCI format which requires or can use a second type channel access procedure (e.g., when the PUSCH is scheduled inside of a BS-initiated COT), the UE may transmit the scheduled PUSCH in response to CAPC #1 being greater than or equal to the CAPC value associated with the UL traffic data carried on the scheduled PUSCH (also when the second type channel access procedure for the scheduled PUSCH is successful). Otherwise, in response to CAPC #1 being smaller than the CAPC value associated with the uplink traffic data carried on the scheduled PUSCH, the UE may terminate the transmission of the scheduled PUSC.

In some embodiments of the present disclosure, the CAPC value (denoted as CAPC #2 for simplicity) indicated in the DCI format scheduling the plurality of PUSCHs may be the CAPC value to be used by the UE for performing a channel access procedure. For instance, a single CAPC value may be indicated in a multi-cell scheduling DCI format and may be the CAPC value to be used by the UE for transmitting the co-scheduled PUSCH(s).

In some embodiments, for a PUSCH scheduled by the DCI format which requires a first type channel access procedure (e.g., when the PUSCH is scheduled outside of a BS-initiated COT), the UE may perform a first type channel access procedure for the scheduled PUSCH according to CAPC #2 before transmitting the scheduled PUSCH. In the case that more than one PUSCH requires a first type channel access procedure (e.g., when the more than one PUSCH is scheduled outside of a BS-initiated COT), the UE may perform a first type channel access procedure for each of the more than one PUSCH according to CAPC #2.

In the case that a PUSCH scheduled by the DCI format requires or can use a second type channel access procedure (e.g., when the PUSCH is scheduled inside of a BS-initiated COT), the BS should ensure that the CAPC value used by the BS for initiating the COT is greater than or equal to the CAPC value associated with the UL traffic data carried on the scheduled PUSCH.

In some embodiments of the present disclosure, the CAPC value indicated in the DCI format scheduling the plurality of PUSCHs may include two separate CAPC values. One CAPC value may be the CAPC value used by the BS for initiating a COT, such as CAPC #1; and the other CAPC value may be the CAPC value to be used by the UE for performing a channel access procedure, such as CAPC #2.

The above descriptions with respect to CAPC #1 and CAPC #2 may apply here. For example, the DCI format may indicate the CAPC value (e.g., CAPC #1) used by the BS when initiating a COT, such that the UE can determine whether a second type channel access procedure can be applicable to those co-scheduled PUSCHs located inside of a BS-initiated COT (i.e., can use a second type channel access procedure). The DCI format may further indicate the CAPC value (e.g., CAPC #2) to be used by the UE for transmitting all the co-scheduled PUSCHs with a first type channel access procedure performed, that is, for those co-scheduled PUSCHs which require a first type channel access procedure.

For example, in the case that more than one PUSCH of the plurality of PUSCHs scheduled by the DCI format is scheduled within a plurality of BS-initiated COTs, CAPC #1 may be the minimum value of CAPC values used by the BS for initiating the plurality of BS-initiated COTs. For example, in the case that more than one PUSCH requires a first type channel access procedure (e.g., when the more than one PUSCH is scheduled outside of a BS-initiated COT), the UE may perform a first type channel access procedure for each of the more than one PUSCH according to CAPC #2.

The aforementioned embodiments for implementing the CPE length indication in a DCI format can apply here. For example, the CPE length indicated in the DCI format scheduling the plurality of PUSCHs may be applied to all of the plurality of PUSCHs. For example, the indicated CPE length may be applied to all PUSCHs that require a first type channel access procedure among the plurality of PUSCHs and a predefined CPE length may be applied to the remaining PUSCHs of the plurality of PUSCHs. For example, the indicated CPE length may be applied to all PUSCHs that require or can use a second type channel access procedure among the plurality of PUSCHs and a predefined CPE length may be applied to the remaining PUSCHs of the plurality of PUSCHs. For example, the indicated CPE length may be applied to a predefined PUSCH among the plurality of PUSCHs and a predefined CPE length may be applied to the remaining PUSCHs of the plurality of PUSCHs. For example, the indicated CPE length may include two CPE lengths, wherein one CPE length may be applied to all PUSCHs that require a first type channel access procedure among the plurality of PUSCHs, and the other CPE length to be applied to all PUSCHs that require or can use a second type channel access procedure among the plurality of PUSCHs. The aforementioned definition for the predefined PUSCH can apply here.

In some embodiments of the present disclosure, when a DCI format schedules a plurality of PUSCHs on a plurality of cells, the DCI format may indicate a channel access type, CAPC value and CPE length for each of the plurality of PUSCHs. For example, the DCI format may include an indicator or a field to indicate the above information, which is hereinafter referred to as indicator #1 for simplicity.

In some embodiments of the present disclosure, indicator #1 may indicate an entry (or a row) of a table, and each entry of the table may indicate a channel access type, a CAPC value and a CPE length for each of the plurality of PUSCHs. The table (denoted as Table #1 for simplicity) may be configured for the UE by a BS (e.g., via RRC) or predefined. The size of (e.g., the number of bits required for) indicator #1 may be dependent on the number of entries in Table #1.

In some embodiments of the present disclosure, each entry of Table #1 may indicate one or more channel access information related indicators for jointly indicating the channel access types, CAPC values, and CPE lengths for PUSCHs co-scheduled by a multi-cell scheduling DCI. For example, assuming that N denotes the maximum number of cells co-scheduled by a single multi-cell scheduling DCI, each entry of Table #1 may include N channel access information related indicators with each corresponding to one of the co-scheduled PUSCHs.

For example, each channel access information related indicator may indicate one combination of channel access type, CAPC and CPE length from another table defined for uplink channel access procedure (e.g., Table A), which may be configured for the UE by a BS (e.g., via RRC) or predefined. For example, this table may be configured via a higher layer parameter ul-AccessConfigListDCI-0-1 or ul-AccessConfigListDCI-0-X.

Exemplary Table #1 is shown below with the assumption of N=4:

Exemplary Table #1: Maximum 4 indicators
(corresponding to 4 PUSCHs) in one entry

| Entry index | Channel access information related indicators |
|---|---|
| 0 | Channel access information related indicator 1, channel |
| | access information related indicator 2, channel access |
| | information related indicator 3, channel access |
| | information related 4 |
| 1 | . . . |
| 2 | . . . |
| . . . | . . . |

In some examples, in the above exemplary Table #1, each of channel access information related indicator 1, channel access information related indicator 2, channel access information related indicator 3, and channel access information related 4 may indicate one entry of Table A.

In some embodiments of the present disclosure, in the case that indicator #1 indicates a first type channel access procedure for a PUSCH of the plurality of PUSCHs scheduled by the DCI format, the associated CAPC value indicated by indicator #1 is the CAPC value to be used by the UE for transmitting the PUSCH.

For example, indicator #1 in the DCI format may indicate channel access information related indicator #n1 for PUSCH #n1 of the plurality of PUSCHs, and in the case that channel access information related indicator #n1 indicates a first type channel access procedure for PUSCH #n1, the CAPC value indicated by channel access information related indicator #n1 is the CAPC value to be used by the UE for transmitting PUSCH #n1.

For example, for PUSCH #n1, the UE can determine whether PUSCH #n1 is scheduled inside or outside of a BS-initiated COT. For example, as described above, based on the remaining COT duration indicator in DCI format 2_0 and the time domain resource allocation information indicated in the DCI format scheduling the plurality of PUSCHs, the UE can determine whether PUSCH #n1 is located inside or outside of a BS-initiated COT.

In response to determining that PUSCH #n1 is scheduled outside of a BS-initiated COT, the UE may perform a first type channel access procedure for PUSCH #n1 according to the associated CAPC value.

Otherwise, in response to determining that PUSCH #n1 is scheduled inside of a BS-initiated COT, it is determined that a second type channel access procedure is required or can be used for PUSCH #n1. In such case, the BS should ensure that the CAPC value used by the BS for initiating the COT is greater than or equal to the CAPC value associated with the UL traffic data carried on PUSCH #n1. In some examples, the UE can further determine the duration of the gap between PUSCH #n1 and the DL or UL transmission (if any) immediately before PUSCH #n1, and further determine whether a Type 2A, 2B or 2C channel access procedure is performed before transmitting PUSCH #n1.

In some embodiments of the present disclosure, in the case that indicator #1 indicates a second type channel access procedure for a PUSCH of the plurality of PUSCHs scheduled by the DCI format, the associated CAPC value indicated by indicator #1 is the CAPC value used by the BS for initiating a COT.

For example, indicator #1 in the DCI format may indicate channel access information related indicator #n1′ for PUSCH #n1′ of the plurality of PUSCHs, and in the case that channel access information related indicator #n1′ indicates a second type channel access procedure for PUSCH #n1′, the CAPC value indicated by channel access information related indicator #n1′ is the CAPC value used by the BS for initiating a COT.

For example, for PUSCH #n1′, the UE can determine whether PUSCH #n1′ is scheduled inside or outside of a BS-initiated COT. For example, as described above, based on the remaining COT duration indicator in DCI format 2_0 and the time domain resource allocation information indicated in the DCI format scheduling the plurality of PUSCHs, the UE can determine whether PUSCH #n1′ is located inside or outside of a BS-initiated COT.

In response to determining that PUSCH #n1′ is scheduled inside of a BS-initiated COT, the UE may determine whether the CAPC value for PUSCH #n1′ indicated by indicator #1 is greater than or equal to the CAPC value associated with the UL traffic data carried on PUSCH #n1′. When the indicated CAPC value is greater than or equal to the CAPC value associated with the UL traffic data carried on PUSCH #n1′, the UE may transmit PUSCH #n1′ in response to a second type channel access procedure for PUSCH #n1′ being successful. Otherwise, when the indicated CAPC value is smaller than the CAPC value associated with the UL traffic data carried on PUSCH #n1′, the UE may terminate the transmission of PUSCH #n1′.

In response to determining that PUSCH #n1′ is scheduled outside of a BS-initiated COT, the UE may perform a first type channel access procedure for PUSCH #n1′ according to the CAPC value associated with the UL traffic data carried on PUSCH #n1′.

In some embodiments of the present disclosure, when a DCI format schedules a plurality of PUSCHs on a plurality of cells, the DCI format may indicate a channel access type, CAPC value and CPE length for a predefined PUSCH of the plurality of PUSCHs. For example, the DCI format may include an indicator or a field to indicate the above information, which is hereinafter referred to as indicator #2 for simplicity.

In some embodiments of the present disclosure, indicator #2 may indicate an entry (or a row) of a table, and each entry of the table may indicate a single channel access type, a single CAPC value and a single CPE length for a predefined PUSCH of the plurality of PUSCHs. The table (denoted as Table #2 for simplicity) may be configured for the UE by a BS (e.g., via RRC) or predefined. For example, Table #2 may be configured via a higher layer parameter ul-AccessConfigListDCI-0-1 or ul-AccessConfigListDCI-0-X. The size of (e.g., the number of bits required for) indicator #2 may be dependent on the number of entries in Table #2. In some examples, Table #2 may be defined similar to Table A.

The aforementioned definition for the predefined PUSCH can apply here. For example, the predefined PUSCH may be: the first scheduled PUSCH among the plurality of PUSCHs co-scheduled by the DCI format: the last scheduled PUSCH among the plurality of PUSCHs; the PUSCH among the plurality of PUSCHs scheduled on a cell with the lowest cell index among the plurality of cells co-scheduled by the DCI format: the PUSCH among the plurality of PUSCHs scheduled on a cell with the largest cell index among the plurality of cells; the first scheduled PUSCH among PUSCHs which require a first type channel access procedure among the plurality of PUSCHs; the last scheduled PUSCH among PUSCHs which require a first type channel access procedure among the plurality of PUSCHs; the PUSCH on a cell with the lowest cell index among PUSCHs which require a first type channel access procedure among the plurality of PUSCHs; the PUSCH on a cell with the largest cell index among PUSCHs which require a first type channel access procedure among the plurality of PUSCHs; the first scheduled PUSCH among PUSCHs which require a second type channel access procedure among the plurality of PUSCHs; the last scheduled PUSCH among PUSCHs which require a second type channel access procedure among the plurality of PUSCHs; the PUSCH on a cell with the lowest cell index among PUSCHs which require a second type channel access procedure among the plurality of PUSCHs; or the PUSCH on a cell with the largest cell index among PUSCHs which require a second type channel access procedure among the plurality of PUSCHs.

In some embodiments of the present disclosure, in the case that indicator #2 indicates a first type channel access procedure for the predefined PUSCH, the associated CAPC value indicated by indicator #2 is the CAPC value to be used by the UE for transmitting the predefined PUSCH. In some embodiments of the present disclosure, in the case that indicator #2 indicates a second type channel access procedure for the predefined PUSCH, the associated CAPC value indicated by indicator #2 is the CAPC value used by the BS for initiating a COT.

For example, indicator #2 in the DCI format may indicate a channel access type, a CAPC value, and a CPE length for a predefined PUSCH (denoted as PUSCH #n2) of the plurality of PUSCHs scheduled by the DCI format.

In the case that the indicated channel access type is a first type channel access procedure, the indicated CAPC value is the CAPC value to be used by the UE for transmitting PUSCH #n2. The UE may perform a first type channel access procedure for PUSCH #n2 according to the indicated CAPC value in the case that PUSCH #n2 is scheduled outside of a BS-initiated COT. For example, as described above, based on the remaining COT duration indicator in DCI format 2_0 and the time domain resource allocation information indicated in the DCI format scheduling the plurality of PUSCHs, the UE can determine whether PUSCH #n2 is located inside or outside of a BS-initiated COT. On the other hand, in response to determining that PUSCH #n2 is scheduled inside of a BS-initiated COT, a second type channel access procedure is required or can be used for PUSCH #n2. In such case, the BS should ensure that the CAPC value used by the BS for initiating the COT is greater than or equal to the CAPC value associated with the UL traffic data carried on PUSCH #n2. In some examples, the UE can further determine the duration of the gap between PUSCH #n2 and the DL or UL transmission (if any) immediately before PUSCH #n2, and further determine whether a Type 2A, 2B or 2C channel access procedure is performed before transmitting PUSCH #n2.

In the case that the indicated channel access type is a second type channel access procedure, the indicated CAPC value is the CAPC value used by the BS for initiating a COT. If it is determined that PUSCH #n2 is scheduled inside of a BS-initiated COT and the indicated CAPC value is greater than or equal to the CAPC value of UL traffic carried on PUSCH #n2, the UE may transmit PUSCH #n2 in response to a second type channel access procedure for PUSCH #n2 being successful. If it is determined that PUSCH #n2 is scheduled inside of a BS-initiated COT and the indicated CAPC value is smaller than the CAPC value of UL traffic carried on PUSCH #n2, the UE may terminate the transmission of PUSCH #n2. If it is determined that PUSCH #n2 is scheduled outside of a BS-initiated COT, the UE may perform a first type channel access procedure for PUSCH #n2 according to the CAPC value associated with the UL traffic data carried on PUSCH #n2.

Regarding the remaining co-scheduled PUSCHs, in some embodiments of the present disclosure, a first type channel access procedure may be required for each of them. That is, a first type channel access procedure may be mandated for transmitting the plurality of PUSCHs except the predefined PUSCH. The CAPC value for a PUSCH among the plurality of PUSCHs except the predefined PUSCH may be determined according to the UL traffic data carried on the corresponding PUSCH. For example, the CAPC value used by the first type channel access procedure is the CAPC value associated with the UL traffic data carried on the corresponding PUSCH.

In some other embodiments of the present disclosure, for each of the plurality of PUSCHs except the predefined PUSCH, the channel access type for a corresponding PUSCH may be determined based on whether the corresponding PUSCH is scheduled inside or outside of a BS-initiated COT.

For example, for a corresponding PUSCH of the plurality of PUSCHs except the predefined PUSCH, the UE can determine whether the corresponding PUSCH is scheduled inside or outside of a BS-initiated COT. The method for determining whether a PUSCH is scheduled inside or outside of a BS-initiated COT as described above may apply here.

In response to determining that the corresponding PUSCH is scheduled outside of a BS-initiated COT, it is determined that a first type channel access procedure is required for the corresponding PUSCH and a CAPC value for the corresponding PUSCH can be determined according to UL traffic carried on the corresponding PUSCH. For example, the UE may perform a first type channel access procedure using the CAPC value associated with the UL traffic carried on the corresponding PUSCH before transmitting the corresponding PUSCH. Otherwise, in response to determining that the corresponding PUSCH is scheduled inside of a BS-initiated COT, it is determined that a second type channel access procedure is required or can be used for the corresponding PUSCH. The UE may perform a second type channel access procedure before transmitting the corresponding PUSCH in the COT. In such case, the BS should ensure that the CAPC value used by the BS for initiating the COT is greater than or equal to the CAPC value associated with the UL traffic data carried on the corresponding PUSCH. The method for determining which of the second type channel access procedures (e.g., Type 2A, 2B or 2C channel access procedure) should be performed as described above may apply here.

A predefined CPE length may be applied to all of the plurality of PUSCHs except the predefined PUSCH. For example, the CPE length of “0” may be used for transmitting each of the plurality of PUSCHs except the predefined PUSCH.

In some embodiments of the present disclosure, when a DCI format schedules a plurality of PUSCHs on a plurality of cells, the DCI format may indicate a single channel access type, a single CAPC value and a single CPE length for all of the plurality of PUSCHs. For example, the DCI format may include an indicator or a field to indicate the above information, which is hereinafter referred to as indicator #3 for simplicity.

In some embodiments of the present disclosure, indicator #3 may indicate an entry (or a row) of a table, and each entry of the table may indicate a single channel access type, a single CAPC value and a single CPE length for all of the plurality of PUSCHs. That is, all of the co-scheduled PUSCHs correspond to the same channel access type, CAPC value and CPE length. The table (denoted as Table #3 for simplicity) may be configured for the UE by a BS (e.g., via RRC) or predefined. For example, Table #3 may be configured via a higher layer parameter ul-AccessConfigListDCI-0-1 or ul-AccessConfigListDCI-0-X. The size of (e.g., the number of bits required for) indicator #3 may be dependent on the number of entries in Table #3. In some examples, Table #3 may be defined similar to Table A.

In some embodiments of the present disclosure, in the case that indicator #3 indicates a first type channel access procedure for all the co-scheduled PUSCHs, the associated CAPC value indicated by indicator #3 is the CAPC value to be used by the UE for transmitting the co-scheduled PUSCHs. In some embodiments of the present disclosure, in the case that indicator #3 indicates a second type channel access procedure for all the co-scheduled PUSCHs, the associated CAPC value indicated by indicator #3 is the CAPC value used by the BS for initiating a COT.

For example, indicator #3 in the DCI format may indicate a channel access type, a CAPC value, and a CPE length for all of the plurality of PUSCHs scheduled by the DCI format.

In the case that the indicated channel access type is a first type channel access procedure, the indicated CAPC value is the CAPC value to be used by the UE for transmitting the plurality of PUSCHs. The UE may perform a first type channel access procedure for a PUSCH (denoted as PUSCH #n3) of the plurality of PUSCHs according to the indicated CAPC value in the case that PUSCH #n3 is scheduled outside of a BS-initiated COT. For example, as described above, based on the remaining COT duration indicator in DCI format 2_0 and the time domain resource allocation information indicated in the DCI format scheduling the plurality of PUSCHs, the UE can determine whether PUSCH #n3 is located inside or outside of a BS-initiated COT. On the other hand, in response to determining that PUSCH #n3 is scheduled inside of a BS-initiated COT, a second type channel access procedure is required or can be used for PUSCH #n3. In such case, the BS should ensure that the CAPC value used by the BS for initiating the COT is greater than or equal to the CAPC value associated with the UL traffic data carried on PUSCH #n3. In some examples, the UE can further determine the duration of the gap between PUSCH #n3 and the DL or UL transmission (if any) immediately before PUSCH #n3, and further determine whether a Type 2A, 2B or 2C channel access procedure is performed before transmitting PUSCH #n3.

In the case that the indicated channel access type is a second type channel access procedure, the indicated CAPC value is the CAPC value used by the BS for initiating a COT. If it is determined that PUSCH #n3 is scheduled inside of a BS-initiated COT and the indicated CAPC value is greater than or equal to the CAPC value of UL traffic carried on PUSCH #n3, the UE may transmit PUSCH #n3 in response to a second type channel access procedure for PUSCH #n3 being successful. If it is determined that PUSCH #n3 is scheduled inside of a BS-initiated COT and the indicated CAPC value is smaller than the CAPC value of UL traffic carried on PUSCH #n3, the UE may terminate the transmission of PUSCH #n3. If it is determined that PUSCH #n3 is scheduled outside of a BS-initiated COT, the UE may perform a first type channel access procedure for PUSCH #n3 according to the CAPC value associated with the UL traffic data carried on PUSCH #n3.

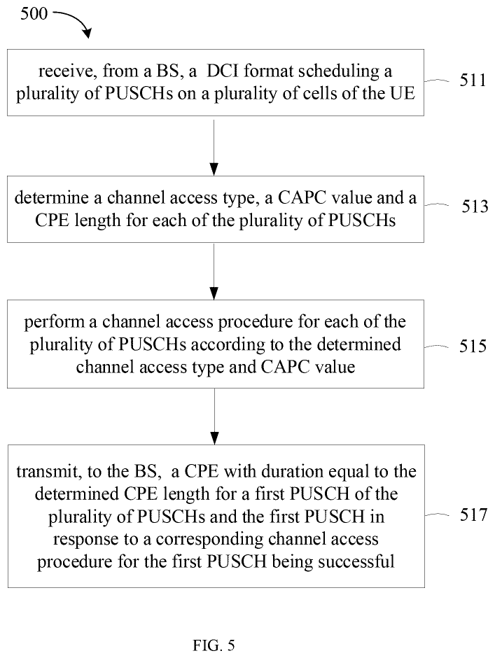

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 101 in FIG. 1.

Referring to FIG. 5, in operation 511, the UE may receive, from a BS, a DCI format scheduling a plurality of PUSCHs on a plurality of cells of the UE. In operation 513, the UE may determine a channel access type, a CAPC value and a CPE length for each of the plurality of PUSCHs. For example, the UE may use the methods as described in the foregoing embodiments of the present disclosure or any combination thereof to determine the channel access type, the CAPC value and the CPE length for each of the plurality of PUSCHs.

In operation 515, the UE may perform a channel access procedure for each of the plurality of PUSCHs according to the determined channel access type, CAPC value and CPE length. In operation 517, the UE may transmit, to the BS, a CPE with duration equal to the determined CPE length for a first PUSCH of the plurality of PUSCHs and the first PUSCH in response to a corresponding channel access procedure for the first PUSCH being successful.

In some embodiments of the present disclosure, a predefined CPE length (e.g., 0) may be applied to all of the plurality of PUSCHs. For example, in response to a channel access procedure for a certain PUSCH being successful, the UE may transmit the PUSCH using the predefined CPE length.

In some embodiments of the present disclosure, determining the CAPC value for each of the plurality of PUSCHs may include determining a CAPC value for a PUSCH that requires a first type channel access procedure among the plurality of PUSCHs according to UL traffic data carried on the PUSCH.

In some embodiments of the present disclosure, a first type channel access procedure may be required for all of the plurality of PUSCHs. In some embodiments of the present disclosure, determining the channel access type for each of the plurality of PUSCHs may include, for a corresponding PUSCH of the plurality of PUSCHs, determining whether the corresponding PUSCH is scheduled inside or outside of a BS-initiated COT; and determining that a first type channel access procedure is required for the corresponding PUSCH in response to determining that the corresponding PUSCH is scheduled outside of the BS-initiated COT. In some embodiments of the present disclosure, determining the channel access type for each of the plurality of PUSCHs may include, for a corresponding PUSCH of the plurality of PUSCHs, determining whether the corresponding PUSCH is scheduled inside or outside of a BS-initiated COT; and determining that a second type channel access procedure is required for the corresponding PUSCH in response to determining that the corresponding PUSCH is scheduled inside of the BS-initiated COT.

In some embodiments of the present disclosure, the DCI format may indicate at least one of: a CPE length; a CAPC value: a first indicator (e.g., indicator #1) for indicating a channel access type, CAPC value and CPE length for each of the plurality of PUSCHs; a second indicator (e.g., indicator #2) for indicating the channel access type, CAPC value and CPE length for a predefined PUSCH of the plurality of PUSCHs; or a third indicator (e.g., indicator #3) for indicating a single channel access type, a single CAPC value and a single CPE length for all of the plurality of PUSCHs.

In some embodiments of the present disclosure, in the case that the DCI format indicates a CPE length, the indicated CPE length may be applied to all of the plurality of PUSCHs; the indicated CPE length may be applied to all PUSCHs that require a first type channel access procedure among the plurality of PUSCHs and a predefined CPE length may be applied to the remaining PUSCHs of the plurality of PUSCHs; the indicated CPE length may be applied to all PUSCHs that require a second type channel access procedure among the plurality of PUSCHs and a predefined CPE length may be applied to the remaining PUSCHs of the plurality of PUSCHs; the indicated CPE length may be applied to a predefined PUSCH among the plurality of PUSCHs and a predefined CPE length may be applied to the remaining PUSCHs of the plurality of PUSCHs; or the indicated CPE length may include a first CPE length to be applied to all PUSCHs that require a first type channel access procedure among the plurality of PUSCHs, and a second CPE length to be applied to all PUSCHs that require a second type channel access procedure among the plurality of PUSCHs.

In some embodiments of the present disclosure, in the case that the DCI format indicates a CAPC value; the indicated CAPC value may be a first CAPC value (e.g., CAPC #1) used by the BS for initiating a COT; the indicated CAPC value may be a second CAPC value (e.g., CAPC #2) to be used by the UE for performing a channel access procedure for transmitting a PUSCH; or the indicated CAPC value may include the first CAPC value and the second CAPC value.

In some embodiments of the present disclosure, in the case that a PUSCH of the plurality of PUSCHs is scheduled inside of the COT initiated by the BS, the UE may transmit the PUSCH in response to the first CAPC value being greater than or equal to a CAPC value associated with uplink traffic data carried on the PUSCH and a second type channel access procedure for the PUSCH being successful. In some embodiments of the present disclosure, in the case that a PUSCH of the plurality of PUSCHs is scheduled inside of the COT initiated by the BS, the UE may terminate the transmission of the PUSCH in response to the first CAPC value being smaller than the CAPC value associated with the uplink traffic data carried on the PUSCH.

In some embodiments of the present disclosure, in the case that more than one PUSCH of the plurality of PUSCHs is scheduled within a plurality of BS-initiated COTs, the first CAPC value may be the minimum value of CAPC values used by the BS for initiating the plurality of BS-initiated COTs.

In some embodiments of the present disclosure, performing a channel access procedure for each of the plurality of PUSCHs according to the determined CAPC value may include performing a first type channel access procedure for a PUSCH of the plurality of PUSCHs according to the second CAPC value.

In some embodiments of the present disclosure, in the case that the DCI format indicates both a CAPC value and a CPE length, the CAPC value and the CPE length may be indicated by separate fields in the DCI format, or jointly indicated by a single field in the DCI format.

In some embodiments of the present disclosure, in the case that the first, second or third indicator indicates a first type channel access procedure for a PUSCH of the plurality of PUSCHs, an associated CAPC value indicated by the first, second or third indicator may be a CAPC value to be used by the UE for transmitting the PUSCH. In some embodiments of the present disclosure, in the case that the first, second or third indicator indicates a second type channel access procedure for a PUSCH of the plurality of PUSCHs, an associated CAPC value indicated by the first, second or third indicator may be a CAPC value used by the BS for initiating a COT.

In some embodiments of the present disclosure, performing a channel access procedure for each of the plurality of PUSCHs according to the determined CAPC value may include performing a first type channel access procedure for the PUSCH according to the associated CAPC value in the case that the PUSCH is scheduled outside of a BS-initiated COT.

In some embodiments of the present disclosure, in the case that the PUSCH is scheduled inside of a BS-initiated COT, when the associated CAPC value is greater than or equal to a CAPC value of uplink (UL) traffic data carried on the PUSCH, the UE may transmit the PUSCH in response to a second type channel access procedure for the PUSCH being successful. In some embodiments of the present disclosure, in the case that the PUSCH is scheduled inside of a BS-initiated COT, when the associated CAPC value is smaller than the CAPC value of the UL traffic data carried on the PUSCH, the UE may terminate the transmission of the PUSCH.

In some embodiments of the present disclosure, in the case that the DCI format indicates the second indicator, the UE may use the methods as described in the foregoing embodiments of the present disclosure or any combination thereof to determine the channel access type, the CAPC value and the CPE length for the plurality of PUSCHs except the predefined PUSCH.

For example, in some embodiments of the present disclosure, a predefined CPE length is applied to all of the plurality of PUSCHs except the predefined PUSCH.

For example, in some embodiments of the present disclosure, a first type channel access procedure is required for all of the plurality of PUSCHs except the predefined PUSCH. For a corresponding PUSCH of the plurality of PUSCHs except the predefined PUSCH, the UE may determine a CAPC value for the corresponding PUSCH according to UL traffic data carried on the corresponding PUSCH. For example, the UE may perform a first type channel access procedure for the corresponding PUSCH using the CAPC value associated with the UL traffic data carried on the corresponding PUSCH.

For example, in some embodiments of the present disclosure, determining the channel access type and CAPC value for each of the plurality of PUSCHs may include: for a corresponding PUSCH of the plurality of PUSCHs except the predefined PUSCH, determining whether the corresponding PUSCH is scheduled inside or outside of a BS-initiated COT; and determining that a first type channel access procedure is required for the corresponding PUSCH and determining a CAPC value for the corresponding PUSCH according to UL traffic data carried on the corresponding PUSCH in response to determining that the corresponding PUSCH is scheduled outside of the BS-initiated COT.

For example, in some embodiments of the present disclosure, determining the channel access type and CAPC value for each of the plurality of PUSCHs may include: for a corresponding PUSCH of the plurality of PUSCHs except the predefined PUSCH, determining whether the corresponding PUSCH is scheduled inside or outside of a BS-initiated COT; and determining that a second type channel access procedure is required for the corresponding PUSCH in response to determining that the corresponding PUSCH is scheduled inside of the BS-initiated COT.

The aforementioned definition for the predefined PUSCH can apply here. For example, the predefined PUSCH may be: the first scheduled PUSCH among the plurality of PUSCHs; the last scheduled PUSCH among the plurality of PUSCHs; a PUSCH among the plurality of PUSCHs scheduled on a cell with the lowest cell index among the plurality of cells; a PUSCH among the plurality of PUSCHs scheduled on a cell with the largest cell index among the plurality of cells; the first scheduled PUSCH among PUSCHs which require a first type channel access procedure among the plurality of PUSCHs; the last scheduled PUSCH among PUSCHs which require a first type channel access procedure among the plurality of PUSCHs; a PUSCH on a cell with the lowest cell index among PUSCHs which require a first type channel access procedure among the plurality of PUSCHs; a PUSCH on a cell with the largest cell index among PUSCHs which require a first type channel access procedure among the plurality of PUSCHs; the first scheduled PUSCH among PUSCHs which require a second type channel access procedure among the plurality of PUSCHs; the last scheduled PUSCH among PUSCHs which require a second type channel access procedure among the plurality of PUSCHs; a PUSCH on a cell with the lowest cell index among PUSCHs which require a second type channel access procedure among the plurality of PUSCHs; or a PUSCH on a cell with the largest cell index among PUSCHs which require a second type channel access procedure among the plurality of PUSCHs.

In some embodiments of the present disclosure, the first indicator may indicate an entry of a table, and each entry of the table may indicate a channel access type, a CAPC value and a CPE length for each of the plurality of PUSCHs.

In some embodiments of the present disclosure, the second indicator may indicate an entry of a table, and each entry of the table may indicate a single channel access type, a single CAPC value and a single CPE length for a predefined PUSCH among PUSCHs scheduled by a single DCI format.

In some embodiments of the present disclosure, the third indicator may indicate an entry of a table, and each entry of the table may indicate a single channel access type, a single CAPC value and a single CPE length for all PUSCHs scheduled by a single DCI format.

In some embodiments of the present disclosure, a size of the first, second, or the third indicator in the DCI format may depend on the number of entries in the table.

In some embodiments of the present disclosure, in the case that a PUSCH of the plurality of PUSCHs is scheduled inside of a BS-initiated COT, the CAPC value used by the BS for initiating the BS-initiated COT may be greater than or equal to a CAPC value of UL traffic data carried on the PUSCH.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a BS, for example, BS 102 in FIG. 1.

Referring to FIG. 6, in operation 611, a BS may transmit, to a UE, a DCI format scheduling a plurality of PUSCHs on a plurality of cells of the UE.

In operation 613, the BS may receive, from the UE, a first PUSCH of the plurality of PUSCHs in response to a channel access procedure for the first PUSCH being successful, wherein the channel access procedure for the first PUSCH is performed by the UE according to a channel access type and a channel access priority class (CAPC) value, and wherein a cyclic prefix extension (CPE) is transmitted by the UE before the first PUSCH.

In some embodiments of the present disclosure, a predefined CPE length is applied to all of the plurality of PUSCHs.

In some embodiments of the present disclosure, in the case that a PUSCH of the plurality of PUSCHs requires a first type channel access procedure, a CAPC value for the PUSCH is determined by the UE according to UL traffic data carried on the PUSCH.

In some embodiments of the present disclosure, a first type channel access procedure is required for all of the plurality of PUSCHs. In some embodiments of the present disclosure, in the case that a PUSCH of the plurality of PUSCHs is scheduled outside of a BS-initiated COT, a first type channel access procedure is required for the UE for transmitting the PUSCH. In some embodiments of the present disclosure, in the case that the PUSCH is scheduled inside of a BS-initiated COT, a second type channel access procedure is required for the UE for transmitting the PUSCH.

In some embodiments of the present disclosure, the DCI format indicates at least one of: a CPE length; a CAPC value: a first indicator for indicating a channel access type, CAPC value and CPE length for each of the plurality of PUSCHs; a second indicator for indicating the channel access type, CAPC value and CPE length for a predefined PUSCH of the plurality of PUSCHs; or a third indicator for indicating a single channel access type, a single CAPC value and a single CPE length for all of the plurality of PUSCHs.

In some embodiments of the present disclosure, in the case that the DCI format indicates a CPE length; the indicated CPE length is applied to all of the plurality of PUSCHs; the indicated CPE length is applied to all PUSCHs that require a first type channel access procedure among the plurality of PUSCHs and a predefined CPE length is applied to the remaining PUSCHs of the plurality of PUSCHs; the indicated CPE length is applied to all PUSCHs that require a second type channel access procedure among the plurality of PUSCHs and a predefined CPE length is applied to the remaining PUSCHs of the plurality of PUSCHs; the indicated CPE length is applied to a predefined PUSCH among the plurality of PUSCHs and a predefined CPE length is applied to the remaining PUSCHs of the plurality of PUSCHs; or the indicated CPE length includes a first CPE length to be applied to all PUSCHs that require a first type channel access procedure among the plurality of PUSCHs, and a second CPE length to be applied to all PUSCHs that require a second type channel access procedure among the plurality of PUSCHs.

In some embodiments of the present disclosure, in the case that the DCI format indicates a CAPC value; the indicated CAPC value is a first CAPC value used by the BS for initiating a COT; the indicated CAPC value is a second CAPC value to be used by the UE for performing channel access procedure for transmitting a PUSCH; or the indicated CAPC value includes the first CAPC value and the second CAPC value.

In some embodiments of the present disclosure, in the case the first CAPC value is greater than or equal to a CAPC value of UL traffic data carried on a PUSCH of the plurality of PUSCHs that requires a second type channel access procedure, the BS may attempt to receive the PUSCH. In some embodiments of the present disclosure, in the case the first CAPC value is smaller than the CAPC value of the UL traffic data carried on the PUSCH, the BS may determine that the transmission of the PUSCH is terminated.

In some embodiments of the present disclosure, in the case that more than one PUSCH of the plurality of PUSCHs is scheduled within a plurality of BS-initiated COTs, the first CAPC value is the minimum value of CAPC values used by the BS for initiating the plurality of BS-initiated COTs.

In some embodiments of the present disclosure, in the case that a PUSCH of the plurality of PUSCHs requires a first type channel access procedure, a first type channel access procedure is performed by the UE for transmitting the PUSCH according to the second CAPC value.

In some embodiments of the present disclosure, in the case that the DCI format indicates both a CAPC value and a CPE length, the CAPC value and the CPE length are indicated by separate fields in the DCI format, or jointly indicated by a single field in the DCI format.

In some embodiments of the present disclosure, in the case that the first, second or third indicator indicates a first type channel access procedure for a PUSCH of the plurality of PUSCHs, an associated CAPC value indicated by the first, second or third indicator is a CAPC value to be used by the UE for transmitting the PUSCH. In some embodiments of the present disclosure, in the case that the first, second or third indicator indicates a second type channel access procedure for a PUSCH of the plurality of PUSCHs, an associated CAPC value indicated by the first, second or third indicator is a CAPC value used by the BS for initiating a COT.

In some embodiments of the present disclosure, in the case that the PUSCH is scheduled outside of a BS-initiated COT, the channel access procedure for the PUSCH is a first type channel access procedure performed according to the associated CAPC value.

In some embodiments of the present disclosure, in the case that the PUSCH is scheduled inside of a BS-initiated COT, the BS may attempt to receive the PUSCH when the associated CAPC value is greater than or equal to a CAPC value of UL traffic data carried on the PUSCH. In some embodiments of the present disclosure, in the case that the PUSCH is scheduled inside of a BS-initiated COT, the BS may determine that the transmission of the PUSCH is terminated when the associated CAPC value is smaller than the CAPC value of the UL traffic data carried on the PUSCH.

In some embodiments of the present disclosure, a predefined CPE length is applied to all of the plurality of PUSCHs except the predefined PUSCH.

In some embodiments of the present disclosure, a first type channel access procedure is required for all of the plurality of PUSCHs except the predefined PUSCH.

In some embodiments of the present disclosure, for a corresponding PUSCH of the plurality of PUSCHs except the predefined PUSCH, in the case that the corresponding PUSCH is scheduled outside of a BS-initiated COT, a first type channel access procedure is required for the corresponding PUSCH and a CAPC value for the corresponding PUSCH is determined according to UL traffic data carried on the corresponding PUSCH. In some embodiments of the present disclosure, for a corresponding PUSCH of the plurality of PUSCHs except the predefined PUSCH, in the case that the corresponding PUSCH is scheduled inside of a BS-initiated COT, a second type channel access procedure is required for the corresponding PUSCH.

In some embodiments of the present disclosure, the predefined PUSCH is: the first scheduled PUSCH among the plurality of PUSCHs; the last scheduled PUSCH among the plurality of PUSCHs; a PUSCH among the plurality of PUSCHs scheduled on a cell with the lowest cell index among the plurality of cells; a PUSCH among the plurality of PUSCHs scheduled on a cell with the largest cell index among the plurality of cells; the first scheduled PUSCH among PUSCHs which require a first type channel access procedure among the plurality of PUSCHs; the last scheduled PUSCH among PUSCHs which require a first type channel access procedure among the plurality of PUSCHs; a PUSCH on a cell with the lowest cell index among PUSCHs which require a first type channel access procedure among the plurality of PUSCHs; a PUSCH on a cell with the largest cell index among PUSCHs which require a first type channel access procedure among the plurality of PUSCHs; the first scheduled PUSCH among PUSCHs which require a second type channel access procedure among the plurality of PUSCHs; the last scheduled PUSCH among PUSCHs which require a second type channel access procedure among the plurality of PUSCHs; a PUSCH on a cell with the lowest cell index among PUSCHs which require a second type channel access procedure among the plurality of PUSCHs; or a PUSCH on a cell with the largest cell index among PUSCHs which require a second type channel access procedure among the plurality of PUSCHs.

In some embodiments of the present disclosure, the first indicator indicates an entry of a table, and each entry of the table indicates a channel access type, a CAPC value and a CPE length for each of the plurality of PUSCHs.

In some embodiments of the present disclosure, the second indicator indicates an entry of a table, and each entry of the table indicates a single channel access type, a single CAPC value and a single CPE length for a predefined PUSCH among PUSCHs scheduled by a single DCI format.

In some embodiments of the present disclosure, the third indicator indicates an entry of a table, and each entry of the table indicates a single channel access type, a single CAPC value and a single CPE length for all PUSCHs scheduled by a single DCI format.

In some embodiments of the present disclosure, a size of the first, second, or the third indicator in the DCI format depends on the number of entries in the table.

In some embodiments of the present disclosure, in the case that a PUSCH of the plurality of PUSCHs is scheduled inside of a BS-initiated COT, the CAPC value used by the BS for initiating the BS-initiated COT is greater than or equal to a CAPC value of UL traffic data carried on the PUSCH.

It should be appreciated by persons skilled in the art that the sequence of the operations in exemplary procedure 600 may be changed and some of the operations in exemplary procedure 600 may be eliminated or modified, without departing from the spirit and scope of the disclosure.

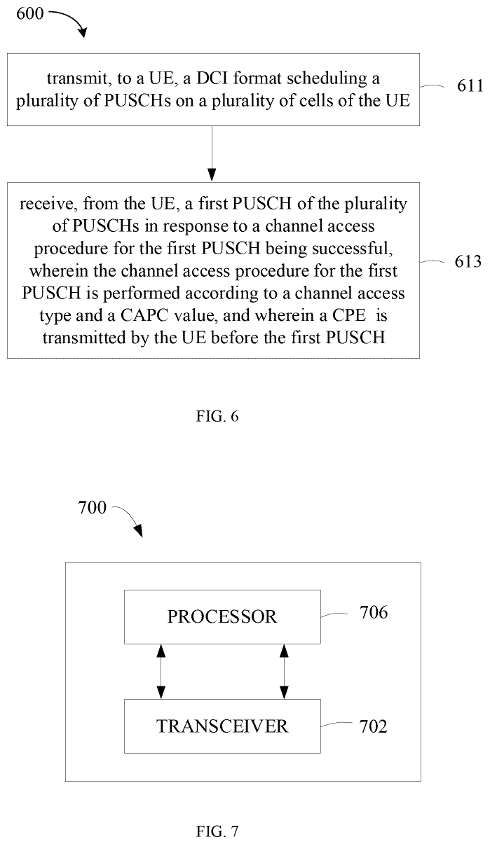

FIG. 7 illustrates a block diagram of exemplary apparatus 700 according to some embodiments of the present disclosure. As shown in FIG. 7, the apparatus 700 may include at least one processor 706 and at least one transceiver 702 coupled to the processor 706. The apparatus 700 may be a UE or a BS.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UE described in FIGS. 1-6. In some embodiments of the present application, the apparatus 700 may be a BS. The transceiver 702 and the processor 706 may interact with each other so as to perform the operations with respect to the BS described in FIGS. 1-6.

In some embodiments of the present application, the apparatus 700 may further include at least one non-transitory computer-readable medium.

For example, in some embodiments of the present disclosure, the non-transitory computer-readable medium may have stored thereon computer-executable instructions to cause the processor 706 to implement the method with respect to the UE as described above. For example, the computer-executable instructions, when executed, cause the processor 706 interacting with transceiver 702 to perform the operations with respect to the UE described in FIGS. 1-6.

In some embodiments of the present disclosure, the non-transitory computer-readable medium may have stored thereon computer-executable instructions to cause the processor 706 to implement the method with respect to the BS as described above. For example, the computer-executable instructions, when executed, cause the processor 706 interacting with transceiver 702 to perform the operations with respect to the BS described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first.” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive, from a base station (BS), a downlink control information (DCI) format scheduling a plurality of physical uplink shared channels (PUSCHs) on a plurality of cells of the UE;
determine a channel access type, a channel access priority class (CAPC) value, and a cyclic prefix extension (CPE) length for each of the plurality of PUSCHs;
perform a channel access procedure for each of the plurality of PUSCHs according to the determined channel access type and CAPC value; and
transmit, to the BS, a CPE with a duration equal to the determined CPE length for a first PUSCH of the plurality of PUSCHs and the first PUSCH in response to a corresponding channel access procedure for the first PUSCH being successful.

2. The UE of claim 1, wherein the DCI format indicates at least one of:
a CPE length;
a CAPC value;
a first indicator for indicating a channel access type, CAPC value, and CPE length for each of the plurality of PUSCHs;
a second indicator for indicating the channel access type, CAPC value, and CPE length for a predefined PUSCH of the plurality of PUSCHs; or
a third indicator for indicating a single channel access type, a single CAPC value, and a single CPE length for all PUSCHs of the plurality of PUSCHs.

3. The UE of claim 2, wherein, when the DCI format indicates a CPE length:
the indicated CPE length is applied to all PUSCHs of the plurality of PUSCHs;
the indicated CPE length is applied to all PUSCHs that require a first type channel access procedure among the plurality of PUSCHs and a predefined CPE length is applied to remaining PUSCHs of the plurality of PUSCHs;
the indicated CPE length is applied to all PUSCHs that require a second type channel access procedure among the plurality of PUSCHs and a predefined CPE length is applied to remaining PUSCHs of the plurality of PUSCHs;
the indicated CPE length is applied to a predefined PUSCH among the plurality of PUSCHs and a predefined CPE length is applied to remaining PUSCHs of the plurality of PUSCHs; or
the indicated CPE length comprises a first CPE length to be applied to all PUSCHs that require a first type channel access procedure among the plurality of PUSCHs, and a second CPE length to be applied to all PUSCHs that require a second type channel access procedure among the plurality of PUSCHs.

4. The UE of claim 1, wherein a predefined CPE length is applied to all PUSCHs of the plurality of PUSCHs.

5. The UE of claim 2, wherein, when the DCI format indicates a CAPC value:
the indicated CAPC value is a first CAPC value used by the BS for initiating a channel occupancy time (COT);
the indicated CAPC value is a second CAPC value to be used by the UE for performing a channel access procedure for transmitting a PUSCH; or
the indicated CAPC value comprises the first CAPC value and the second CAPC value.

6. The UE of claim 5, wherein the at least one processor is further configured to cause the UE to:
when a PUSCH of the plurality of PUSCHs is scheduled inside of the COT initiated by the BS,
transmit the PUSCH in response to the first CAPC value being greater than or equal to a CAPC value associated with uplink (UL) traffic data carried on the PUSCH and a second type channel access procedure for the PUSCH being successful; or
terminate transmission of the PUSCH in response to the first CAPC value being smaller than the CAPC value associated with the UL traffic data carried on the PUSCH.

7. The UE of claim 1, wherein determining the CAPC value for each of the plurality of PUSCHs comprises determining a CAPC value for a PUSCH that requires a first type channel access procedure among the plurality of PUSCHs according to uplink (UL) traffic data carried on the PUSCH.

8. The UE of claim 1, wherein a first type channel access procedure is required for all of the plurality of PUSCHs; or
wherein determining the channel access type for each of the plurality of PUSCHs comprises, for a corresponding PUSCH of the plurality of PUSCHs,
determining whether the corresponding PUSCH is scheduled inside or outside of a BS-initiated channel occupancy time (COT); and
determining that a first type channel access procedure is required for the corresponding PUSCH in response to determining that the corresponding PUSCH is scheduled outside of the BS-initiated COT; or
determining that a second type channel access procedure is required for the corresponding PUSCH in response to determining that the corresponding PUSCH is scheduled inside of the BS-initiated COT.

9. The UE of claim 2, wherein, when the first, second, or third indicator indicates a first type channel access procedure for a PUSCH of the plurality of PUSCHs, an associated CAPC value indicated by the first, second, or third indicator is a CAPC value to be used by the UE for transmitting the PUSCH; and
wherein, when the first, second, or third indicator indicates a second type channel access procedure for a PUSCH of the plurality of PUSCHs, an associated CAPC value indicated by the first, second, or third indicator is a CAPC value used by the BS for initiating a channel occupancy time (COT).

10. The UE of claim 9, wherein the at least one processor is further configured to cause the UE to, when the PUSCH is scheduled inside of a BS-initiated COT:
when the associated CAPC value is greater than or equal to a CAPC value of uplink (UL) traffic data carried on the PUSCH, transmit the PUSCH in response to a second type channel access procedure for the PUSCH being successful; or
when the associated CAPC value is smaller than the CAPC value of the UL traffic data carried on the PUSCH, terminate transmission of the PUSCH.

11. The UE of claim 2, wherein a predefined CPE length is applied to all of the plurality of PUSCHs except the predefined PUSCH; and
wherein a first type channel access procedure is required for all of the plurality of PUSCHs except the predefined PUSCH; or
wherein determining the channel access type and CAPC value for each of the plurality of PUSCHs comprises: for a corresponding PUSCH of the plurality of PUSCHs except the predefined PUSCH,
determining whether the corresponding PUSCH is scheduled inside or outside of a BS-initiated channel occupancy time (COT); and
determining that a first type channel access procedure is required for the corresponding PUSCH and determining a CAPC value for the corresponding PUSCH according to uplink (UL) traffic data carried on the corresponding PUSCH in response to determining that the corresponding PUSCH is scheduled outside of the BS-initiated COT; or
determining that a second type channel access procedure is required for the corresponding PUSCH in response to determining that the corresponding PUSCH is scheduled inside of the BS-initiated COT.

12. The UE of claim 2, wherein the predefined PUSCH is:
the first scheduled PUSCH among the plurality of PUSCHs;
the last scheduled PUSCH among the plurality of PUSCHs;
a PUSCH among the plurality of PUSCHs scheduled on a cell with a lowest cell index among the plurality of cells;
a PUSCH among the plurality of PUSCHs scheduled on a cell with a largest cell index among the plurality of cells;
the first scheduled PUSCH among PUSCHs which require a first type channel access procedure among the plurality of PUSCHs;
the last scheduled PUSCH among PUSCHs which require a first type channel access procedure among the plurality of PUSCHs;
a PUSCH on a cell with the lowest cell index among PUSCHs which require a first type channel access procedure among the plurality of PUSCHs;
a PUSCH on a cell with the largest cell index among PUSCHs which require a first type channel access procedure among the plurality of PUSCHs;
the first scheduled PUSCH among PUSCHs which require a second type channel access procedure among the plurality of PUSCHs;
the last scheduled PUSCH among PUSCHs which require a second type channel access procedure among the plurality of PUSCHs;
a PUSCH on a cell with the lowest cell index among PUSCHs which require a second type channel access procedure among the plurality of PUSCHs; or
a PUSCH on a cell with the largest cell index among PUSCHs which require a second type channel access procedure among the plurality of PUSCHs.

13. The UE of claim 2, wherein the first indicator indicates an entry of a table, and each entry of the table indicates a channel access type, a CAPC value, and a CPE length for each of the plurality of PUSCHs; or
wherein the second indicator indicates an entry of a table, and each entry of the table indicates a single channel access type, a single CAPC value, and a single CPE length for a predefined PUSCH among PUSCHs scheduled by a single DCI format; or
wherein the third indicator indicates an entry of a table, and each entry of the table indicates a single channel access type, a single CAPC value, and a single CPE length for all PUSCHs scheduled by a single DCI format.

14. A base station (BS) for wireless communication, comprising:
at least one memory; and
at least one processor coupled with the at least one memory and configured to cause the BS to:
transmit, to a user equipment (UE), a downlink control information (DCI) format scheduling a plurality of physical uplink shared channels (PUSCHs) on a plurality of cells of the UE; and
receive, from the UE, a first PUSCH of the plurality of PUSCHs in response to a channel access procedure for the first PUSCH being successful, wherein the channel access procedure for the first PUSCH is performed by the UE according to a channel access type and a channel access priority class (CAPC) value, and wherein a cyclic prefix extension (CPE) is transmitted by the UE before the first PUSCH.

15. A method performed by a user equipment (UE), the method comprising:
receiving, from a base station (BS), a downlink control information (DCI) format scheduling a plurality of physical uplink shared channels (PUSCHs) on a plurality of cells of the UE;
determining a channel access type, a channel access priority class (CAPC) value, and a cyclic prefix extension (CPE) length for each of the plurality of PUSCHs;
performing a channel access procedure for each of the plurality of PUSCHs according to the determined channel access type and CAPC value; and
transmitting, to the BS, a CPE with a duration equal to the determined CPE length for a first PUSCH of the plurality of PUSCHs and the first PUSCH in response to a corresponding channel access procedure for the first PUSCH being successful.

16. The method of claim 15, wherein the DCI format indicates at least one of:
a CPE length;
a CAPC value;
a first indicator for indicating a channel access type, CAPC value, and CPE length for each of the plurality of PUSCHs;
a second indicator for indicating the channel access type, CAPC value, and CPE length for a predefined PUSCH of the plurality of PUSCHs; or
a third indicator for indicating a single channel access type, a single CAPC value, and a single CPE length for all PUSCHs of the plurality of PUSCHs.

17. The method of claim 16, wherein, when the DCI format indicates a CPE length:
the indicated CPE length is applied to all PUSCHs of the plurality of PUSCHs;
the indicated CPE length is applied to all PUSCHs that require a first type channel access procedure among the plurality of PUSCHs and a predefined CPE length is applied to remaining PUSCHs of the plurality of PUSCHs;
the indicated CPE length is applied to all PUSCHs that require a second type channel access procedure among the plurality of PUSCHs and a predefined CPE length is applied to remaining PUSCHs of the plurality of PUSCHs;
the indicated CPE length is applied to a predefined PUSCH among the plurality of PUSCHs and a predefined CPE length is applied to remaining PUSCHs of the plurality of PUSCHs; or
the indicated CPE length comprises a first CPE length to be applied to all PUSCHs that require a first type channel access procedure among the plurality of PUSCHs, and a second CPE length to be applied to all PUSCHs that require a second type channel access procedure among the plurality of PUSCHs.

18. The method of claim 16, wherein, when the DCI format indicates a CAPC value:
the indicated CAPC value is a first CAPC value used by the BS for initiating a channel occupancy time (COT);
the indicated CAPC value is a second CAPC value to be used by the UE for performing a channel access procedure for transmitting a PUSCH; or
the indicated CAPC value comprises the first CAPC value and the second CAPC value.

19. The method of claim 16, wherein a predefined CPE length is applied to all PUSCHs of the plurality of PUSCHs.

20. The method of claim 16, wherein determining the CAPC value for each of the plurality of PUSCHs comprises determining a CAPC value for a PUSCH that requires a first type channel access procedure among the plurality of PUSCHs according to uplink (UL) traffic data carried on the PUSCH.
